(19) United States
(12) Patent Application Publication
(10) Pub. No.: US 2006/0255899 A1
(43) Pub. Date: Nov. 16, 2006

(54) Choke coils

(75) Inventors: Cheng-Hong Lee, Taoyuan Hsien (TW); Yi-Hong Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/366,475

(22) Filed: Mar. 3, 2006

(30) Foreign Application Priority Data
May 13, 2005 (TW) 94115569

(51) Int. Cl. H01F 27/24

(52) U.S. Cl. 336/212

(57) ABSTRACT

Choke coils are provided. A choke coil includes a bobbin, a coil and a core. The coil is wound around the bobbin. The core is coupled to the bobbin and includes a first structure and a second structure. The choke coil eliminates common mode noise, differential mode noise, and high-frequency noise.

This Non-provisional application claims priority under U.S.C.§ 119(a) on Patent Application No(s). 094115569, filed in Taiwan, Republic Of China on May 13, 2005, the entire contents of which are hereby incorporated by reference.

### BACKGROUND

The invention relates to choke coils, and in particular to choke coils capable of eliminating common mode noise, differential mode noise, and high-frequency noise.

Electronic devices are commonly used nowadays. Most of the electronic devices are driven by electricity. A common type of electricity from plugs in the wall is called alternating current. Alternating current usually generates noise due to power supply, high-frequency transformer, or operation of the parasitic capacitance and stray capacitance of other components in the device, commonly referred to as electrical interference.

Generally, noise generated when using alternating current includes differential mode noise and common mode noise. EMI filters can be the first defense against electromagnetic radiation. An EMI filter is mainly composed of a choke coil and a capacitor, and the choke coil can restrain generation of noise or prevent noise from entering the electrical devices or electrical apparatuses. Referring to FIG. 1A, which shows a core 1 of a conventional choke coil as disclosed in U.S. Pat. No. 4,587,507. In FIG. 1, the core 1 of a chock coil consists of a coiled thin strip of an amorphous alloy, and has at least one cut air gap 2. In view of the disadvantages of the amorphous alloy like the operating frequency thereof to absorb noise being often lower than 100 kHz, and low resistance to DC-bias, the cut air gap 2 is formed in the core 1 in order to modify the resistance to DC-bias; however, the initial permeability (μi) of the choke coil is greatly reduced.

FIG. 1B shows another conventional choke coil, as disclosed in U.S. Pat. No. 6,456,182, in which three individual magnetic cores 11a, 11b and 11c are integrated to make up a choke coil 11 which can eliminate common mode noise. The cores 11a, 11b and 11c are made of oxide magnetic substance, and an insulating material or viscose is applied between each core to separate them from each other. Since the choke coil (2) is made of the oxide magnetic substance having the high permeability, the impedance in the low frequency band (10 kHz side) is large. Also, the permeability in the high-frequency band (10 MHz side) is high due to the dimensional resonance phenomenon, and then the impedance is large. However, three cores joined together tend to increase overall volume of the choke coil, which is disadvantageous to miniaturization. Further, this type of choke coil eliminates only common mode noise, not differential mode noise.

FIG. 1C shows another conventional choke coil, as disclosed in U.S. Pat. No. 5,581,224, including two individual cores, an outer core 111 and an inner core 114 wound together by a coil 18. The outer core 111 is made of a material with a large magnetic permeability, such as ferrite or amorphous, and the inner core 114 is made of a material with a relative low magnetic permeability, such as dust core. Between the two cores 111 and 114, there is an insulating material keeping them isolated. The high permeability of the outer core 111 may eliminate common mode noise. Conversely, the low permeability of the inner core 114 may eliminate differential mode noise. Nevertheless, the arrangement of the independent cores maximizes the volume of the choke coil, which is adverse to miniaturization. Further, disposing the insulating material between the cores is costly in both material and time.

Therefore, in both economical and miniaturization of size considerations, a choke coil capable of eliminating both common mode noise and differential mode noise is desirous.

### SUMMARY

In view of the above, the present invention provides choke coils capable of eliminating common mode noise, differential mode noise, and high-frequency noise effectively. Also, it decreases manufacturing costs and occupied space.

An embodiment of a choke coil includes a bobbin, a coil and a core. The core is coupled to the bobbin and includes a first structure and a second structure. The first structure eliminates common mode noise, and the second structure eliminates high-frequency noise. The first structure is embedded in the second structure. The bobbin includes at least one cavity on a surface of the bobbin for accommodating the coil. The bobbin eliminates differential mode noise.

Another embodiment of a choke coil includes a bobbin, a coil and a core. The bobbin eliminates differential mode noise and high-frequency noise, and the core eliminates common mode noise. The bobbin has at least one cavity on a surface of the bobbin for accommodating the coil and the bobbin includes a through hole for allowing the core to pass therethrough. The core is coupled to the bobbin and has ferrite and a thin layer consisted of electrically conductive powders, wherein the ferrite is embedded in the thin layer. The ferrite includes iron, cobalt, nickel, or alloy thereof, and the thin layer includes polymers and highly electrically conductive powders which are selected from a group of carbon fiber, carbon powder, iron, silver, copper, gold, and a mixture thereof. The polymers are polyethylene, polyurethane, or other polymers with relatively low melting point.

The choke coil of the invention can filter and eliminate three different frequency ranges such as common mode noise, differential mode noise, and high-frequency noise by modulating composition of components in the choke coil.

The invention can be more fully understood by reading the subsequent detailed description and examples with references made to the accompanying drawings, wherein:

### DESCRIPTION OF THE DRAWINGS

FIG. 1A is a schematic view of a conventional core as disclosed in U.S. Pat. No. 4,587,507;

FIG. 1B is a schematic view of a conventional core as disclosed in U.S. Pat. No. 6,456,182;

FIG. 1C is a schematic view of a conventional core as disclosed in U.S. Pat. No. 5,581,224;

FIG. 2A is a schematic view of an embodiment of a choke coil;

FIG. 2B is a schematic view of a core in FIG. 2A; and

FIG. 2C is a schematic view of a bobbin in FIG. 2A.

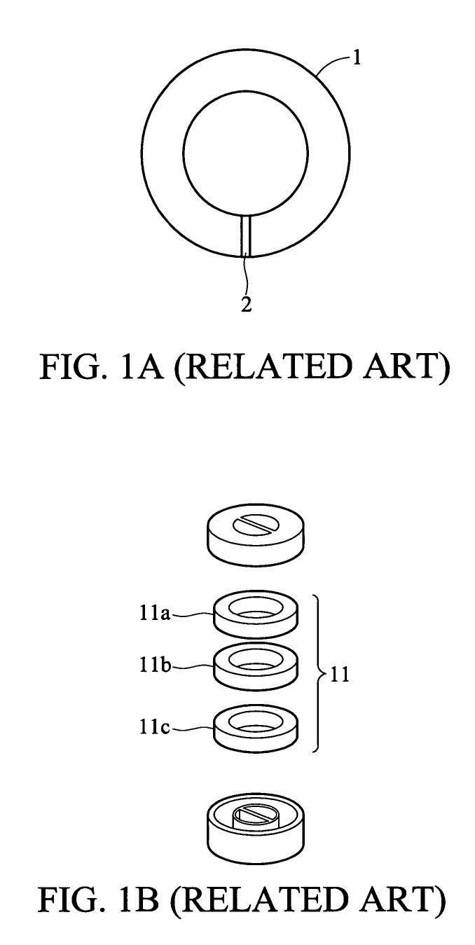

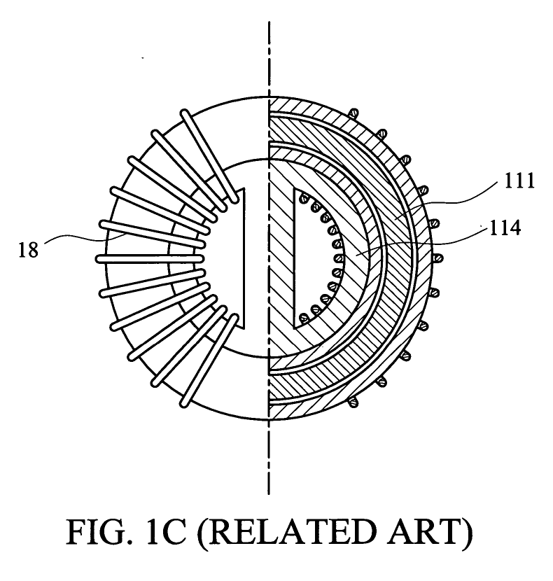

### DETAILED DESCRIPTION

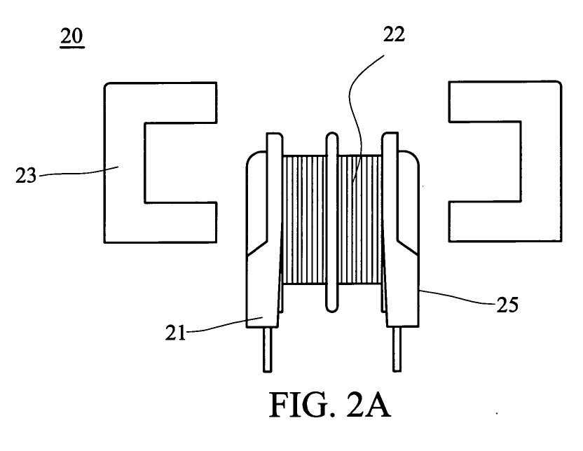

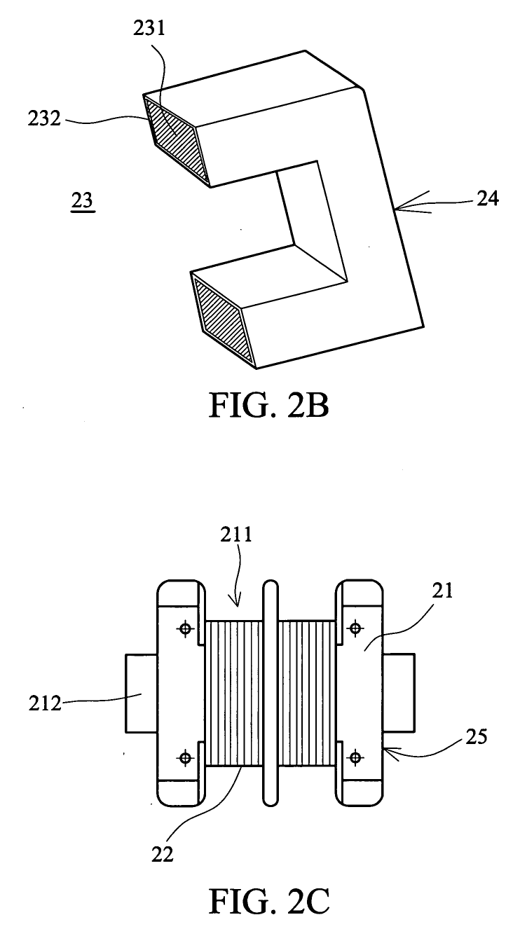

FIG. 2A is a schematic view of an embodiment of a choke coil. As shown in FIG. 2A, a choke coil 20 disclosed in the invention includes a bobbin 21, a coil 22 and a core 23.

FIG. 2B is a schematic view of the core 23 in FIG. 2A. As shown in FIG. 2A, the core 23 includes a first structure 231 and a second structure 232 and the first structure 231 and the second structure 232 are manufactured by the steps described as follows. Firstly, use carbon fibers, of which length from 1 mm to 3 mm, or other highly electrically conductive powders to add and mix with heated and melted macromolecule polymers. The highly electrically conductive powders are selected from a group of carbon fiber, carbon powder, iron, silver, copper, gold, and a mixture thereof. Then the mixture is evenly disposed around the first structure 231 by dipping or spraying to form a thin layer of electrically conductive powders, i.e. the second structure 232. The thickness of the thin layer is from about 0.1 mm to 0.2 mm. Therefore, the first structure 231 is embedded in the second structure 232. Optionally, an insulating layer 24 can be spread on the core 23 so that the insulating layer 24 covers the core 23.

FIG. 2C is a schematic view of the bobbin 21 in FIG. 2A. The bobbin 21 is formed by injection molding technology or powder pressure technology. The bobbin 21 includes a cavity 211 and a through hole 212. The coil 22 is accommodated within the cavity 211, and the through hole 212 is for allowing the core 23 to pass there through. Moreover, an insulating layer 25 is spread on the bobbin 21 so that the insulating layer 25 covers the bobbin 21. When the core 23 with the first structure 231 embedded in the second structure 232 passes through the through hole 212 of the bobbin 21, the assembly of the choke coil is finished.

The bobbin 21 is made of ferrite powders and polymers such as polypropylene or nylon. The ferrite powders are manganese-zinc-ferrite or nickel-zinc-ferrite. The first structure 231 is made of ferrite including iron, cobalt, nickel, or alloy thereof, and the second structure 232 is made of polymers and highly electrically conductive powders, such as carbon fiber, carbon powder, iron, silver, copper, gold, and a mixture thereof. The polymers are polyethylene, polyurethane, or other polymers with relatively low melting point. The second structure 232 is disposed around the first structure 231 by dipping or spraying.

Due to different composition, the bobbin 21 and the first structure 231 have different initial permeability (μ) . Because permeability of the bobbin 21 is less than that of the first structure 231, the bobbin 21 eliminates differential mode noise, and the first structure 231, made of ferrite, eliminates common mode noise. Moreover, the second structure 232 contains electrically conductive powders, which can eliminate high-frequency noise in frequency ranges corresponding to characteristics of the electrically conductive powders.

As the results, the choke coil of the invention capable of effectively eliminating common mode noise, differential mode noise and high-frequency noise. Also, the manufacturing costs and occupied space are decreased.

The choke coil of the invention can be applied in a filtering module for filtering noise in electrical appliances such as power supplies. Moreover, the choke coil can also be applied in an inductor for reduced size thereof.

While the invention has been described by way of example and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A choke coil, comprising:
a bobbin;
a pair of coil wound around the bobbin; and
a core coupled to the bobbin and comprising a first structure and a second structure, wherein the first structure eliminates common mode noise, and the second structure eliminates high-frequency noise.

2. The choke coil as claimed in claim 1, wherein the bobbin comprises a through hole for allowing the core to pass therethrough.

3. The choke coil as claimed in claim 1, wherein the bobbin comprises at least one cavity on a surface of the bobbin for accommodating the coil.

4. The choke coil as claimed in claim 1, wherein the first structure is embedded in the second structure.

5. The choke coil as claimed in claim 1, wherein the second structure is disposed around the first structure by dipping or spraying.

6. The choke coil as claimed in claim 1, wherein the first structure comprises ferrite, and the second structure comprises polymers and highly electrically conductive powders.

7. The choke coil as claimed in claim 6, wherein the highly electrically conductive powders are selected from a group of carbon fiber, carbon powder, iron, silver, copper, gold, and a mixture thereof.

8. The choke coil as claimed in claim 6, wherein the polymers are polyethylene, polyurethane, or other polymers with relatively low melting point.

9. The choke coil as claimed in claim 6, wherein the ferrite comprises iron, cobalt, nickel, or alloy thereof.

10. The choke coil as claimed in claim 1, wherein the bobbin comprises composite materials capable of eliminating differential mode noise.

11. The choke coil as claimed in claim 1, wherein the bobbin comprises ferrite powders and polymers.

12. The choke coil as claimed in claim 11, wherein the ferrite powders are manganese-zinc-ferrite or nickel-zinc-ferrite.

13. The choke coil as claimed in claim 11, wherein the polymers are polypropylene or nylon materials.

14. The choke coil as claimed in claim 1, wherein the bobbin is formed by injection molding technology or powder pressure technology.

15. The choke coil as claimed in claim 1, further comprising an insulating layer covering the bobbin.

16. The choke coil as claimed in claim 1, further comprising an insulating layer covering the core.

17. A choke coil, comprising:
a bobbin;
at least one coil wound around the bobbin; and
a core coupled to the bobbin and comprising ferrite and a thin layer comprising electrically conductive powders, wherein the ferrite is embedded in the thin layer.

18. The choke coil as claimed in claim 17, wherein the ferrite comprises iron, cobalt, nickel, or alloy thereof.

19. The choke coil as claimed in claim 17, wherein the thin layer comprises polymers and highly electrically conductive powders.

20. The choke coil as claimed in claim 19, wherein the highly electrically conductive powders are selected from a group of carbon fiber, carbon powder, iron, silver, copper, gold, and a mixture thereof, and the polymers are polyethylene, polyurethane, or other polymers with relatively low melting point.
